(19) United States
(12) Patent Application Publication
(10) Pub. No.: US 2024/0127334 A1
(43) Pub. Date: Apr. 18, 2024

(54) SYSTEM, METHOD AND APPARATUS FOR PROVIDING DISTRIBUTED LEDGER-BASED APPLICATIONS AND SERVICES TO USERS WITH DISABILITIES

(71) Applicants: Mona Rassouli, Ramsey, NJ (US); Daniel Rassouli, Ramsey, NJ (US)

(72) Inventors: Mona Rassouli, Ramsey, NJ (US); Daniel Rassouli, Ramsey, NJ (US)

(21) Appl. No.: 17/966,534

(22) Filed: Oct. 14, 2022

(51) Int. Cl. G06Q 40/04; G06Q 20/36; G06Q 20/38; G10L 15/26

(52) U.S. Cl. CPC G06Q 40/04; G06Q 20/3678; G06Q 20/389; G10L 15/26; G06Q 2220/00

(57) ABSTRACT

A method and apparatus for providing distributed ledger-based applications or services to physically-impaired users, such as people with visual, hearing and/or motor impairments. Such users may verbally interact with a distributed ledger-based application or service, where verbal requests from a user are sent across the Internet to an accessibility webserver, which interprets the requests and sends the requests to a distributed ledger-based network. The distributed ledger-based network sends a response to the accessibility server, and the accessibility server generates a user response comprising the response from the distributed ledger-based network. The user response is provided to the user device via the Internet, where it is converted into a non-visual format, such as a human voice announcing the result of the user's request.

### BACKGROUND

### I. Field of Use

The present invention relates to distributed ledger-based technology and more specifically to a system, method and apparatus for providing people with hearing and/or visual disabilities access to online, distributed ledger-based applications and services, such as distributed financial services, distributed autonomous organization services, etc.

### II. Description of the Related Art

There are millions of individuals globally who are unable to access and benefit from some of the leading distributed technologies currently available online. For example, blind or visually compromised people may have extreme difficulty opening an account on a cryptocurrency trading platform such as Coinbase and trading cryptocurrencies, because there is presently no way to present feedback to such vision-impaired people to know if, for example, an account has been created, whether a buy/sell/trade/exchange order has been properly constructed and executed. Similarly, vision-impaired people may not be able to participate in distributed autonomous organizations to vote on new proposals due to their inability to receive visual information relating to such proposals. Visually-impaired people may additionally have difficulty in accessing basic, distributed web-based services, such as distributed services that provide multi-signatory document signature services, checking a crypto wallet balance or checking the current price of a cryptocurrency.

It would be desirable, then, to provide a platform for people with audio and/or visual disabilities to be able to access certain distributed ledger-based services.

### SUMMARY

The present disclosure describes embodiments of method and apparatus for providing distributed ledger-based applications and services to users with certain disabilities. In one embodiment, an accessibility webserver is described, comprising a memory for storing processor-executable instructions, a network interface and a processor, coupled to the memory and the network interface, for executing the processor-executable instructions that causes the accessibility webserver to provide, by the processor via the network interface, a listing of commands available for use with a distributed ledger-based application or service to a user device over a wide-area network, the listing of commands formatted for the user device to audibly provide the listing of commands to a user of the user device, receive, by the processor via the network interface, a command for the distributed ledger-based application or service to perform an action, the command provided audibly by the user to the user device, determine, by the processor, a first action to be performed by the distributed ledger-based application or service based on the received command, generate, by the processor, a formatted command comprising the first action, the formatted command formatted for processing by the distributed ledger-based application or service, send, by the processor via the network interface, the formatted command for receipt by the distributed ledger-based application or service, receive, by the processor via the network interface, a response from the distributed ledger-based application or service, the response comprising validated information by a plurality of computing nodes of the distributed ledger-based application or service, and provide, by the processor via the network interface, a user response to the user device based on the response, the user response configured for the user device to provide an audible response to the user.

In another embodiment, a method is described, performed by an accessibility server for providing distributed ledger-based applications and services to users with certain disabilities, comprising providing a listing of commands available for use with a distributed ledger-based application or service to a user device over a wide-area network, the listing of commands formatted for the user device to audibly provide the listing of commands to a user of the user device, receiving a command for the distributed ledger-based application or service to perform an action, the command provided audibly by the user to the user device, determining a first action to be performed by the distributed ledger-based application or service based on the received command, generating a formatted command comprising the first action, the formatted command formatted for processing by the distributed ledger-based application or service, sending the formatted command for receipt by the distributed ledger-based application or service, receiving a response from the distributed ledger-based application or service, the response comprising validated information by a plurality of computing nodes of the distributed ledger-based application or service, and providing a user response to the user device based on the response, the user response configured for the user device to provide an audible response to the user.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 is a functional block diagram showing one embodiment of a system for providing distributed ledger-based applications and services to physically impaired individuals;

FIG. 2 is a functional block diagram of one embodiment of accessibility webserver used in the system shown in FIG. 1; and

FIGS. 3A-3H represent a flow diagram illustrating one embodiment of a method, performed by the accessibility shown in FIGS. 1 and 2, for providing access to distributed ledger-based applications and services for visually and/or hearing-impaired individuals

### DETAILED DESCRIPTION

Embodiments of the present invention relate to a system, method and apparatus for providing access to distributed ledger-based applications and services to people with physical disabilities, such as being deaf or hearing-impaired and/or blind or visually impaired. Users with disabilities may access distributed ledger-based applications and services by connecting to an accessibility webserver via a fixed or mobile computer or communication device. The accessibility webserver may allow users to provide spoken commands to such fixed or mobile computers or communication devices, provide non-visual feedback to the users, and interact with distributed ledger-based applications and services on each user's behalf.

As used herein, the phrase “distributed ledger-based application and service” refers to any computer application or web-based service that relies on distributed ledger technology. The terms “distributed ledger” and “blockchain” may be used interchangeably herein, referring to an output of a distributed ledger network, such as the well-known Bitcoin and Ethereum blockchain networks. A distributed ledger or blockchain is a decentralized, distributed, typically public digital ledger that is used to record transactions processed by a plurality of computing nodes.

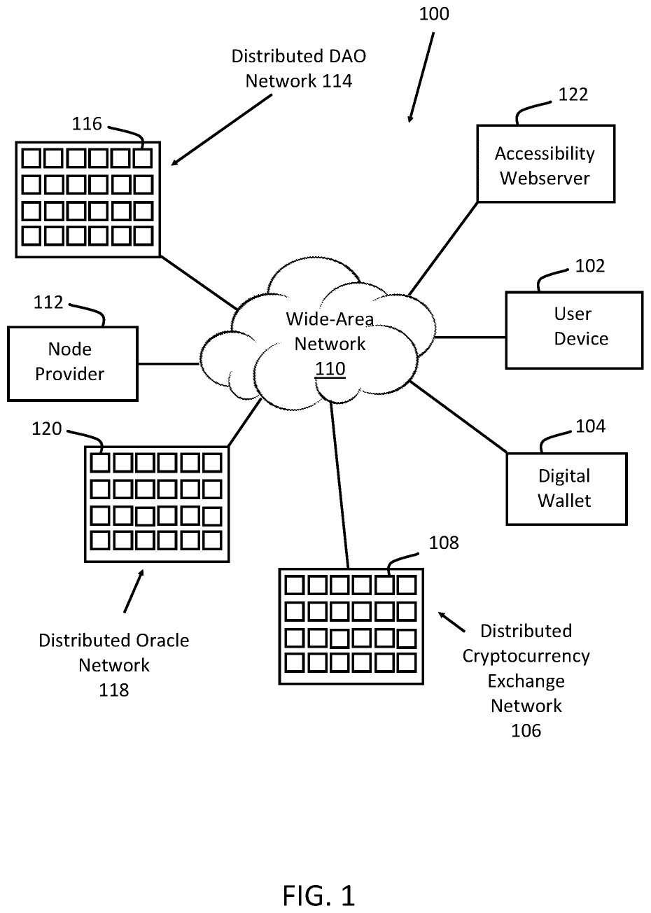

FIG. 1 is a functional block diagram showing one embodiment of a system 100 for providing distributed ledger-based applications and services to physically impaired individuals, such as people with visual, hearing and/or motor skill disabilities. User device 102 comprises a network-compatible communication device, such as a mobile or desktop computer, computer tablet, smart phone, wearable device, etc. that allows a visually and/or audibly impaired individual to access distributed ledger-based applications and services. Although only one user device 102 is shown in FIG. 1, in reality, thousands or even millions of user devices 102 may each allow visually and/or audibly impaired individuals to access distributed ledger-based applications and services. User device 102 allows verbal commands and requests to be input and sent to accessibility server 122 and to receive non-visual responses and feedback from such distributed ledger-based applications and services. Accessibility webserver 122 is configured to receive digitized, verbal requests and commands from user device 102, interpret the verbal commands and requests, and interact with particular distributed ledger-based applications or services on behalf of the user.

For example, a visually-impaired user may verbally request a balance of the user's “crypto wallet”, otherwise referred to herein as a digital wallet 104. Digital wallet 104 may store a variety of different cryptocurrencies or “coins” previously purchased by the user and typically maintained by a crypto wallet provider, such as MetaMask, Gnosis-Safe, etc., or by a cryptocurrency exchange provider, such as Coinbase, Binance, etc. using a distributed cryptocurrency exchange network 106. A user's verbal request is received by user device 102 and forwarded via a wide-area network 110 to accessibility webserver 122. Accessibility webserver 122 receives the user's verbal request and processes it to generate a digital “transcript” of an estimate of what the user said. The transcript may then be operated on by an algorithm, such as an artificial intelligent algorithm, to identify keywords in the transcript, such as words that indicate that a balance request was intended. Accessibility webserver 122 then generates a request, formatted in accordance with one or more protocols of a distributed ledger-based application or service, digital wallet 104, or a node provider 112, as will be discussed in greater detail later herein, and sends the request to a wallet maintenance webserver (not shown) associated with digital wallet 104, distributed cryptocurrency exchange network 106, or node provider 112, via wide-area network 110. The wallet maintenance web server, distributed cryptocurrency exchange network 106 or node provider 112 responds to the request and provides a balance of digital wallet 104, in some cases a total wallet value, or one or more values associated with one or more cryptocurrencies held in digital wallet 104. Accessibility web server 122 receives the response and, in turn, generates a user response message to user device 102 in accordance with the response from the wallet maintenance webserver, distributed cryptocurrency exchange network 106 or node provider 112. The user response message may comprise digital instructions that causes user interface 102 to provide a non-visual response to the user, such as digital instructions that causes user device 102 to issue an audible response of the balance of digital wallet 104. In any of the embodiments described herein, presenting a non-visual response does not preclude additionally providing a visual response, such as displaying the balance on a display screen of user device 102.

Accessibility webserver 122 may also be used to facilitate an exchange of cryptocurrencies to visually and/or audibly compromised users. Such a user may issue a verbal command to user device 102 to initiate an exchange of one cryptocurrency held by the user in digital wallet 104 for another cryptocurrency. For example, the user may utter, “exchange 0.25 Bitcoin for Ether”. User device 102 receives the verbal request and sends the verbal request to accessibility webserver 122 via wide-area network 110. Accessibility web server 122 receives the request to exchange the cryptocurrencies, converts the request to a transcript, and then applies an algorithm to the transcript in order to determine the user's request, and any associated information associated therewith, such as the request type (i.e., buy, sell, exchange, etc.), an identification of two or more cryptocurrencies involved in an exchange, and amount of one cryptocurrency to exchange, a price at which the user would be willing to exchange cryptocurrencies, and other such associated information.

Accessibility webserver 122 determines that the user would like to exchange one cryptocurrency for another and, in one embodiment, forms a distributed ledger-based “transaction proposal” to exchange the identified cryptocurrencies. A distributed ledger-based transaction proposal is a transaction proposal, such as obtaining a digital wallet balance, obtaining a current price of a cryptocurrency, exchanging one cryptocurrency for another, submitting or voting on a DAO proposal, and, in general, interacting with a distributed ledger network. In other embodiments, accessibility webserver 122 formats one or more messages for receipt by a wallet maintenance webserver associated with digital wallet 104 or node provider 112. In any case, the transaction proposal or other formatted messages is/are sent via wide-area network 110 (and, in some embodiments, via node provider 112) to distributed cryptocurrency exchange network 106. Node provider 112 comprises one or more computers that are configured to interface with one or more nodes of one or more distributed ledger networks, such as distributed cryptocurrency exchange network 106, a distributed DAO network 114 and a distributed Oracle network 118. Examples of such node providers include Moralis, Alchemy, and Quicknode.

Distributed cryptocurrency exchange network 106 is configured to exchange cryptocurrencies and, in some cases, manage digital wallet 104. Distributed cryptocurrency exchange network 106 comprises a plurality of digital computing “nodes” 108. Each of the digital computing nodes 108 is configured to validate transaction proposals submitted by accessibility webserver 122 or by intermediaries, such as node provider 112, and to post validated transactions to a distributed ledger, or blockchain, produced by distributed cryptocurrency exchange network 106. Collectively, the digital computing nodes 108 form a distributed ledger, or blockchain, network for validating proposals and for generating the blockchain. Once a transaction proposal is validated and recorded in the blockchain, distributed cryptocurrency exchange network 106 may notify accessibility webserver 122, or an intermediary, of the successful validation and new ownership details concerning the swapped cryptocurrencies. Accessibility webserver 122 receives the notification via wide-area network 110 and may convert the notification into a digital user response message suitable for providing a non-visual notification, by user device 102, to the user. The digital user response message is sent via wide-area network 110 to user device 102, where it is converted into a non-visual response, such as a simulated human voice indicating whether the exchange was successful or not. In some embodiments, the response may comprise a tactile alert generated by user device 102, indicating that the exchange did or did not occur.

In addition to exchanging cryptocurrencies on distributed cryptocurrency exchange network 106, users may also request a balance of digital wallet 104, or the current price of one or more cryptocurrencies. Such requests are verbally issued to user device 102 and provided to accessibility webserver 122 where they are processed in order to determine a request or command issued by the user, and any related attributes. Accessibility webserver 122 then formats and sends one or more messages to distributed cryptocurrency exchange network 106, or an intermediary such as node provider 112, requesting information managed by distributed cryptocurrency exchange network 106. The computing nodes 108 of distributed cryptocurrency exchange network 106 then validate transaction proposals related to the requested information using well-known distributed ledger validation techniques and memorialize validated transactions on a blockchain produced by distributed cryptocurrency exchange network 106. Distributed cryptocurrency exchange network 106 may then notify accessibility server 122 directly, or through an intermediary, of the requested information, such as a current cryptocurrency value. Accessibility server 122 then formats and sends one or more messages to user device 102, for user device 102 to present the requested information non-visually to the user, for example, in an audible format.

As another example, accessibility webserver 122 may allow a visually and/or audibly impaired user to participate as a member of a distributed autonomous organization (DAO), where the user, along with a plurality of other members, act as a distributed, governing body of the organization. DAOs typically rely on smart contracts executed on a distributed ledger or blockchain, such as distributed DAO network 114. The smart contract(s) perform certain functions related to the DAO, such as to receive new proposals from members and to distribute such new proposals to each of the other members, to receive an indication from each of the members whether to approve or deny a new proposal, and then to act on approved proposals, or not, depending on, typically, a majority vote of the members. Distributed DAO network 114 comprises a plurality of computing nodes 116 that form a distributed ledger, or blockchain, network, that validates and records the result of any new, approved proposal in the form of a distributed ledger, or blockchain.

Visually and/or audibly compromised individuals may generate their own DAO proposals and send them via user device 102 to distributed DAO network 114 via accessibility webserver 122 and, in some embodiments, node provider 112. Accessibility webserver 122 allows for the creation of such new proposals by causing user device 102 to provide non-visual instructions to a user, and to receive new proposals submitted verbally by the user.

Users may additionally vote on other members' proposals, by receiving such proposals audibly via user device 102. Another member of the DAO may generate and submit a new proposal to distributed DAO network 114, and distributed DAO network 114 then provides the new proposal to each of the other members, including a visually and/or audibly compromised user via accessibility webserver 122 and user device 102. The new proposal is converted by accessibility webserver 122 into one or more messages is/are sent to user device 102, which instructs user device 102 to deliver the new proposal to the user verbally, i.e., by providing the new proposal in a simulated human voice. The user may respond to the new proposal by verbally approving or disapproving the new proposal. The verbal response is then converted and sent by user device 102 to accessibility web server 122, where it is analyzed to determine the user's response to the new proposal. Once determined, the user's response is formatted in accordance for use by distributed DAO network 114, and then sent to distributed DAO network 114, sometimes via node provider 112, for tabulation with responses submitted to distributed DAO network 114 by other members. One or more smart contracts executed by distributed DAO network 114 then determines whether the new proposal is approved and, if so, performs one or more actions based on the approved proposal, such as to sell a quantity of cryptocoins associated with the DAO. The result of the approved proposal (or not), and the action(s) associated with an approval, may be validated by computer nodes 116 and memorialized by updating the blockchain produced by distributed DAO network 114. Distributed DAO network 114 may additionally notify all members of whether the new proposal was approved or not, by providing a notification to each member and to accessibility webserver 122, which forwards the notification to user device 102 for audible presentation to the user.

Visually and/or audibly compromised users may additionally access other distributed ledger-based services and applications via accessibility webserver 122. In general, accessibility webserver 122 may verbally provide available commands, requests and other options to a user tailored to a particular distributed ledger-based service or application selected by a user, receive requests or commands in accordance with the available options, provide non-visual feedback to the user to confirm receipt of the request or command, determine a desired action from the user's verbal request or command, format a message in accordance with the desired action and send the message to the particular distributed ledger-based application or service, in some cases via node provider 112. A response may be received by the accessibility webserver 122 from the particular distributed ledger-based application or service, or via node provider 112, and the response formatted by accessibility webserver 122 into a user response message for non-visual presentation to the user via user device 102.

For example, a visually impaired user may verbally instruct user device 102 to access a distributed ledger-based service for providing distributed ledger-based inflation data. An example of such a distributed ledger-based inflation reporting service is Truflation, which hosts a website located at www.truflation.com. Truflation provides a web-based service for providing various inflation statistics to users based on multiple sources and validated by a distributed Oracle network, such as distributed Oracle network 118. Distributed Oracle network 118 is a distributed ledger network comprising a plurality of computing nodes 120 configured to receive real-world information, such as inflation statistics, from a variety of sources, validate the inflation information and generate a blockchain that reflects validated inflation statistics. In general, a distributed Oracle network such as distributed Oracle network 118 executes one or more smart contracts in order to provide information from a variety of sources to users via services such as Truflation. In practice, a webserver operated by Truflation may request a variety of inflation statistics from distributed Oracle network 118 (and, in some cases, via node provider 112) and receive such requested data from distributed Oracle network 118 via the blockchain produced by distributed Oracle network 118. One such distributed Oracle network is the well-known Chainlink Oracle (www.chainlink.com). As a specific example of the Truflation service, the webserver operated by Truflation may request certain information relating to real-world inflation statistics, such as an average home selling price in a particular area, the cost of one or more commodities, such as milk, eggs, bread, etc. in a particular area, government statistics such as the consumer price index (CPI), and, in general, the current price of goods and services in a particular area.

Continuing with the Truflation example, a visually-impaired user may access the Truflation service by speaking a command into user device 102, indicating that the user wishes to access the Truflation distributed ledger-based inflation service. The request may be sent to accessibility webserver 122, where accessibility webserver 122 may cause device 102 to provide a verbal menu of commands available for use with the Truflation service. The user may provide verbal requests and commands to user device 102 in accordance with the menu of commands in order to perform such tasks as to request inflation statistics related to a particular subject, category, good, service, etc. and, in some embodiments, related to a particular geographic area of interest to the user. For example, the user may verbally request, for example, the actual consumer inflation percentage for the month of April in the United States. The verbal request is sent by user device 102 to accessibility webserver 122, where it is analyzed to determine a particular command or request supported by Truflation, as well as any associated information, such as a time period, geographic area, etc. The accessibility webserver 122 then generates a message to Truflation, formatted in accordance with a protocol understood by the Truflation webserver. The Truflation webserver may retrieve the requested inflation information from distributed Oracle network 118 and then send the result to accessibility webserver 122. Accessibility webserver 122 receives the result from distributed Oracle network 118 and then formats the result into a user response that can be processed by user device 102 in order to provide a non-visual to the user of user device 102, such as a simulated human voice that provides the requested inflation information to the visually-impaired user.

Of course, the aforementioned Truflation example is just one example of how accessibility webserver 122 may enable a visually-impaired user to access distributed ledger-based services and applications. Accessibility webserver 122 may provide access to a myriad of other distributed ledger-based applications and services.

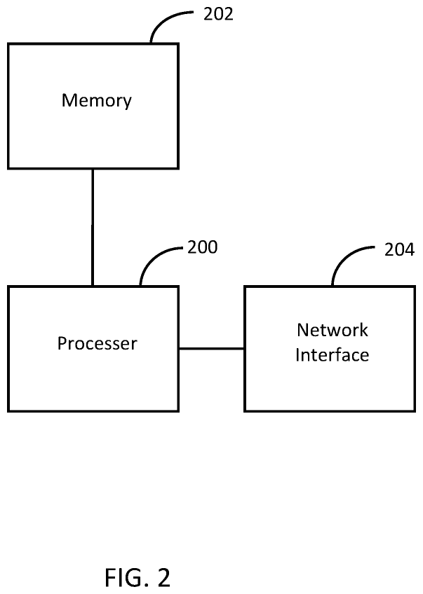

FIG. 2 is a functional block diagram of one embodiment of accessibility webserver 122. Shown is processor 200, non-transitory memory 202, and network interface 204.

Processor 200 is configured to provide general operation of accessibility webserver 122 by executing processor-executable instructions stored in non-transitory memory 202, for example, executable computer code. Processor 200 typically comprises one or more general or specialized microprocessors, microcontrollers, and/or customized ASICs, selected based on computational speed, cost, power consumption, and other factors relevant to such a webserver.

Non-transitory memory 202 is coupled to processor 200, comprising one or more non-transitory electronic, digital information storage devices, such as static and/or dynamic RAM, ROM, flash memory, or some other type of electronic, optical, or mechanical memory device. Non-transitory memory 202 is used to store processor-executable instructions for operation of accessibility webserver 122, as well as information needed to provide access to distributed ledger-based applications and services, such as one or more applications to convert verbal commands into transcripts, one or more algorithms to interpret the transcripts in order to identify keywords and associated information, a listing of cryptocurrencies and related cryptocurrency descriptors, etc. It should be understood that in some embodiments, a portion of non-transitory memory 202 may be embedded into processor 200 and, further, that non-transitory memory 202 excludes propagating signals.

Network interface 204 is coupled to processor 200, comprising circuitry for sending and receiving digital data to/from other devices in system 100 via wide-area network 110, such as user device 102, digital wallet 104, node provider 112, distributed cryptocurrency exchange network 106, distributed DAO network 114, distributed Oracle network 118, and other webservers, for example, the aforementioned Truflation web server and other distributed ledger-based networks. For example, network interface 204 may comprise circuitry and firmware for sending and receiving digital data in the form of TCP/IP packets. Such circuitry is well known in the art.

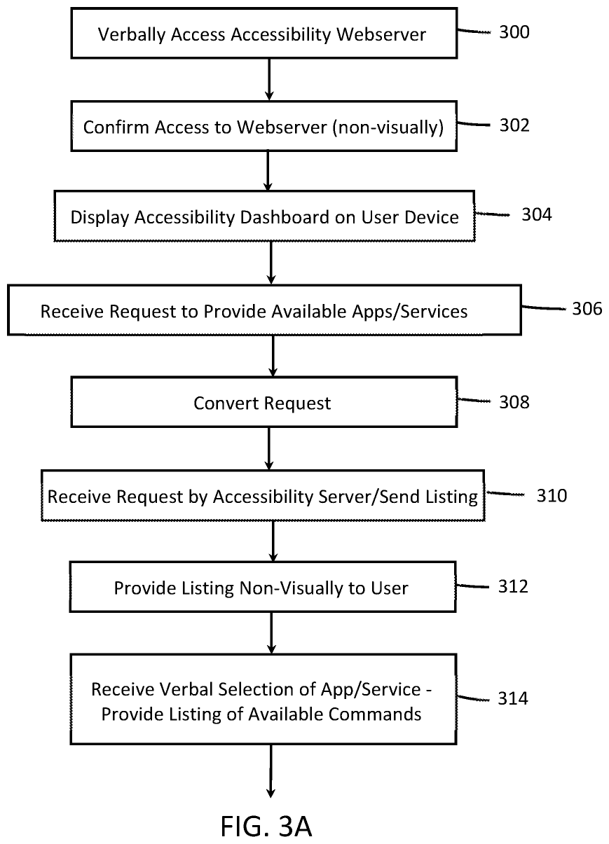

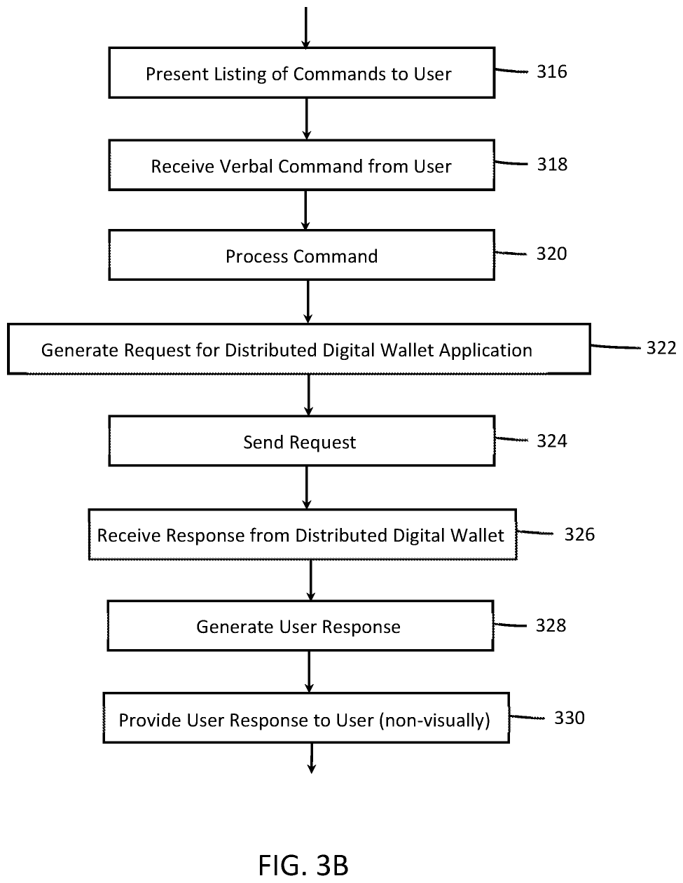

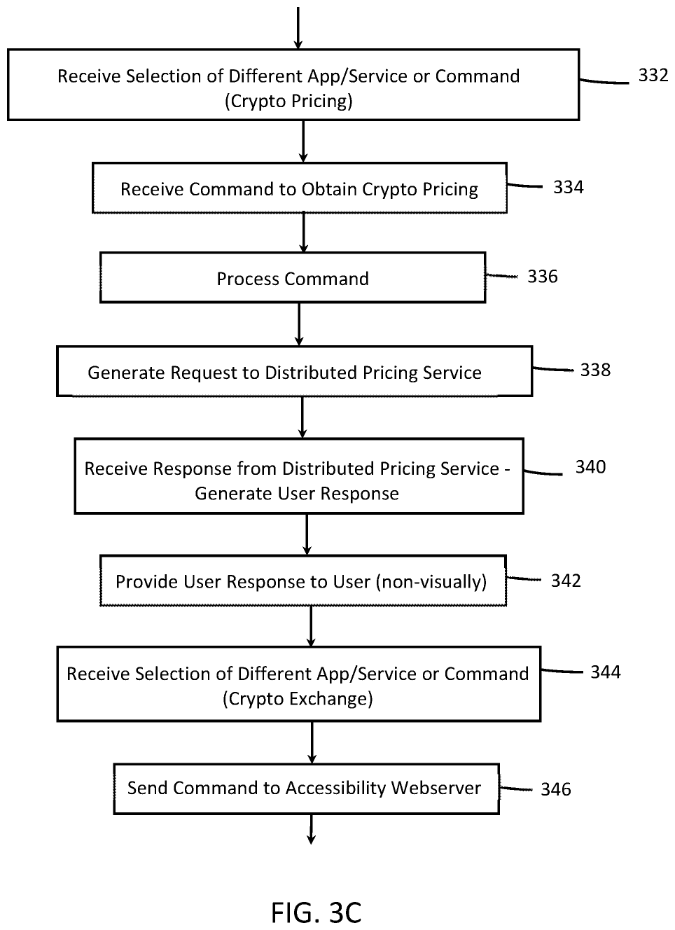

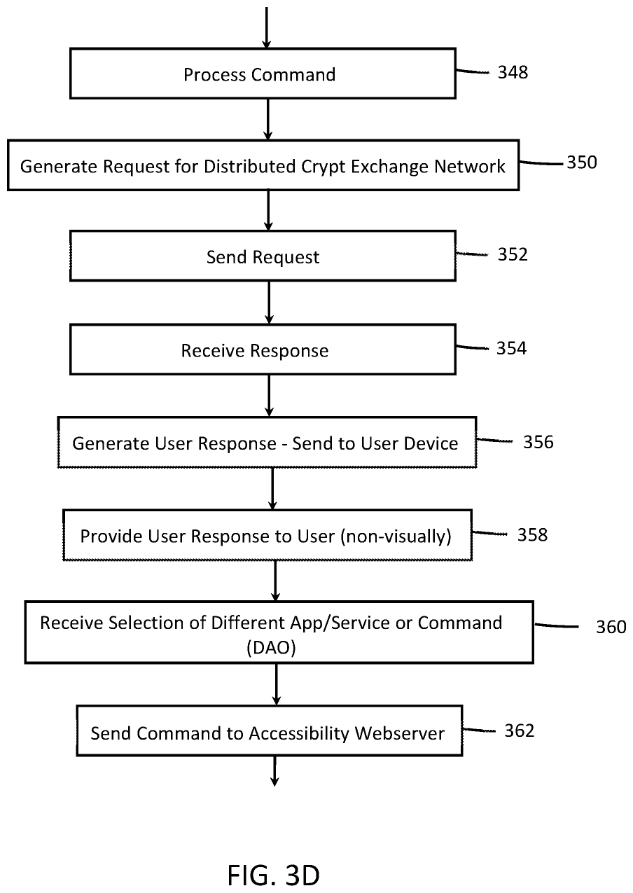

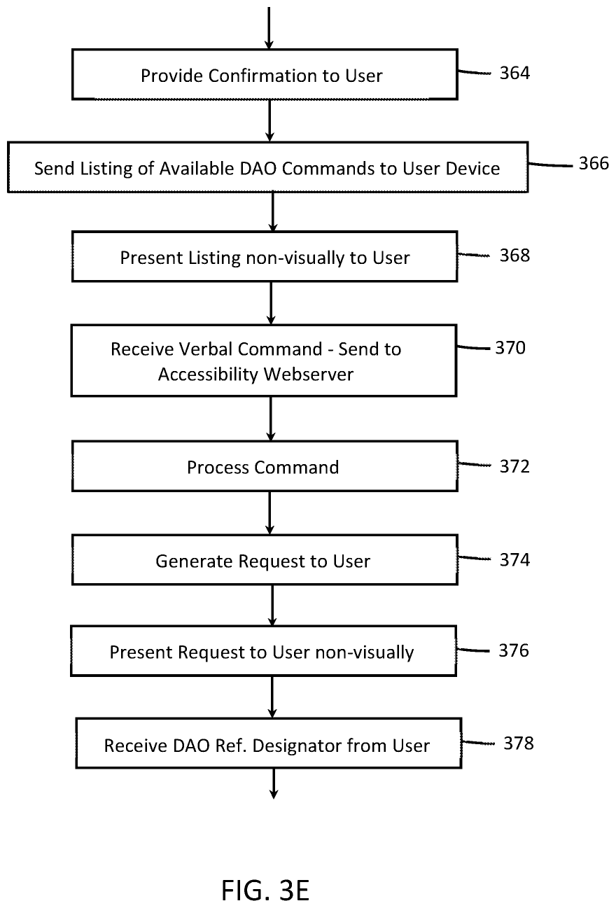

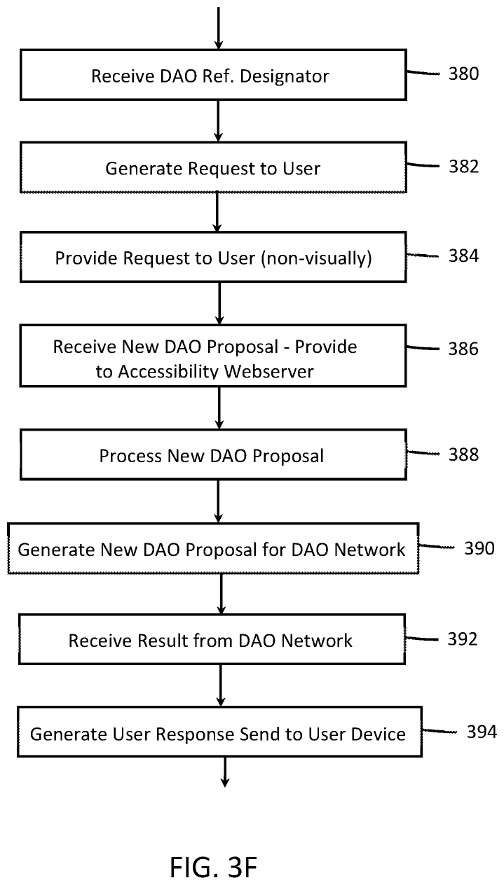

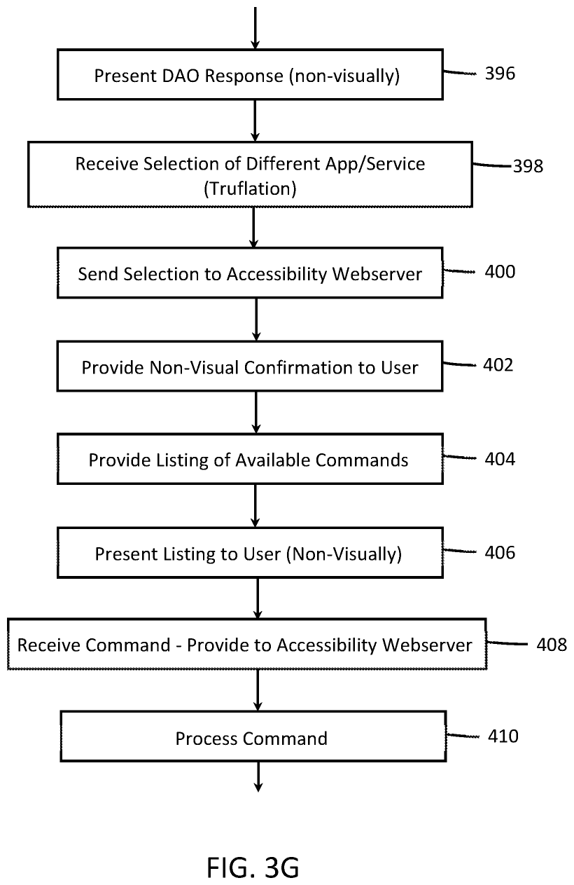

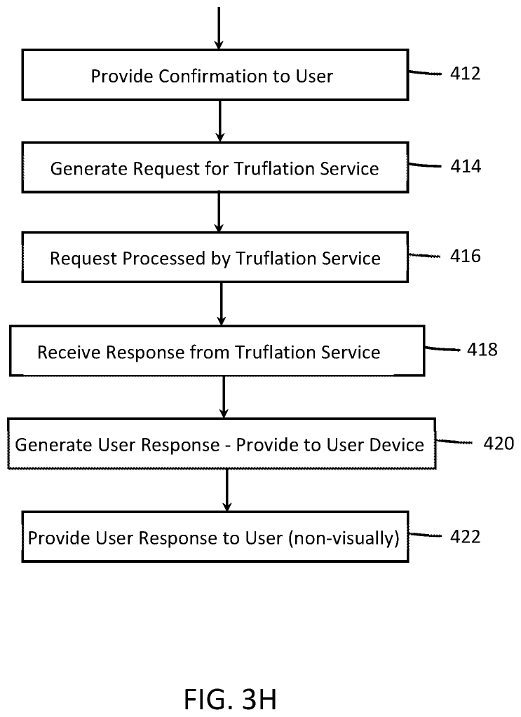

FIGS. 3A-3H represent a flow diagram illustrating one embodiment of a method, performed by accessibility webserver 122 and user device 102, for providing access to distributed ledger-based applications and services for visually and/or hearing-impaired individuals. It should be understood that in some embodiments, not all of the steps shown in FIGS. 3A-3H are performed, and that the order in which the steps are carried out may be different in other embodiments. It should be further understood that some minor method steps have been omitted for purposes of clarity.

At block 300, a visual and/or hearing-impaired user may access accessibility webserver 122 via user device 102 and wide-area network 110, typically by issuing a verbal command for user device 102 to navigate to an accessibility website provided by accessibility webserver 122. User device 102 typically comprises an audio input device, such as a microphone and related circuitry, to receive verbal commands and digitize them for use by user device 102 and accessibility webserver 122. User device 102 typically processes the digitized verbal command and then may automatically open a web browser or app installed on user device 102 in order to access accessibility webserver 122.

At block 302, once accessibility webserver 122 has been accessed, user device 102 may verbally and/or tactilely notify the user that the accessibility website hosted by accessibility webserver 122 has been accessed and is ready for use. For example, user device 102 may emit an audible chirp, time, short audio clip, etc. via a speaker and related circuitry incorporated into user device 102 and/or cause a haptic notification to occur, such as by activating a haptic actuator within user device 102, such as a vibrotactile feedback system.

At block 304, in one embodiment, the accessibility website is displayed to the user, comprising an accessibility dashboard that allows the user to access two or more distributed ledger-based applications or services. For example, the dashboard may display two or more links, tabs, or other means for accessing particular distributed ledger-based applications or services. In one embodiment, the dashboard allows users to select from a service to check a user's digital wallet balance, a service to check the price of one or more cryptocurrencies, a service to exchange cryptocurrencies, a service to participate in a DAO, and a service to check inflation statistics. Of course, the dashboard may display links, tabs or other means to access other distributed ledger-based applications or services, and a greater or fewer number of such distributed ledger-based applications or services. In one embodiment, the dashboard does not comprise links, tabs or other means for accessing different distributed ledger-based applications or services. Rather, the accessibility website allows a user to access distributed ledger-based applications and services simply by issuing verbal commands relevant to particular applications and services. For example, after the dashboard has been accessed, the user may be able to issue a verbal command to check the user's digital wallet balance, as well as to issue a command to swap one cryptocurrency for another.

At block 306, in one embodiment, after the user has been notified that the accessibility website has been accessed and ready to use, the user may verbally request a list of distributed ledger-based applications and services available to the user via the dashboard.

At block 308, the user's verbal request for a listing of available distributed ledger-based applications and services is converted by user device 102 into one or more digital messages compatible with wide-area network 110, such as one or more IP/TCP data packets. The one or more digital messages may be sent by user device 102 to accessibility webserver 122 via wide-area network 110, or user device 102 may process the request internally.

At block 310, processor 200 of accessibility webserver 122 receives the one or more digital messages from user device 102 via network interface 204 and determines that it is a request to provide a listing of available distributed ledger-based applications and services to the user for use with the accessibility web site. In response, processor 200 generates a user response that includes a listing of available applications and services, typically stored in memory 202. The response is provided to user device 102 via network interface 204 and wide-area network 110.

At block 312, user device 102 receives the available applications and services from accessibility webserver 122 for use with the accessibility website, converts it into an audible response, and presents the audible response to the user via a speaker and related circuitry of user device 102.

At block 314, the user may select one of the distributed ledger-based applications or services by speaking a verbal command commensurate with the selected application or service. For example, the user may say, “Wallet Balance”, which may be a command used in connection with the user's digital wallet. In one embodiment, after the user speaks the verbal command, the verbal command may be processed by user device 102 and sent to processor 200 of accessibility webserver 122, as explained above. In response, processor 200 may generate a list of commands available for use with the Wallet Balance service as stored in memory 202 in association with the wallet balance service. The listing of commands is then sent to user device 102 via network interface 204 and wide-area network 110.

At block 316, user device 102 receives the listing of commands for use with the selected application or service, in this case the Wallet Balance service, and presents the listing to the user via non-visual means, such as audibly.

At block 318, the user may issue a verbal command in connection with the selected application or service. For example, the user may say, “retrieve wallet balance” or “how much Bitcoin do I have?”, for example. The verbal command is received by user device 102 and sent to accessibility webserver 122, as explained above. In one embodiment, user device 102 may verbally and/or tactilely notify the user that the user's command has been received successfully.

At block 320, processor 200 of accessibility webserver 122 receives the command and determines which command was issued. In one embodiment, processor 200 processes the command using a speech recognition library, such as the well-known React speech recognition library, to generate a transcript of potential words spoken by the user. The transcript is then processed, in some embodiments by processor-executable instructions in accordance with the well-known Python programming language using an artificial intelligence-based algorithm, to match the potential words in the transcript with available commands in accordance with the particular distributed ledger-based application or service, which may be stored in memory 202. The transcript is also processed in order to determine attributes of each command, such as one or more cryptocurrency types. For example, the user may want to know how much Bitcoin and Ether is in digital wallet 104, where the command “how much” is determined and then the words “Bitcoin” and “Ether” are determined. In one embodiment, the algorithm used to interpret the transcript is tailored towards commands likely used by the particular distributed ledger-based service or application. For example, for an application or service that provides digital wallet balances, the algorithm may be trained to identify words likely to appear with such a service, such as “check” “balance”, and various cryptocurrencies that could be in a user's wallet, such as “Bitcoin”, “Ether”, “DAO”, “Ripple”, etc. In one embodiment, processor 200 additionally generates a confirmation and sends the confirmation to user device 102 via network interface 204 and wide-area network 110. The confirmation instructs user device 102 to provide an audible and/or tactile notification to the user that the user's command has been received and/or processed successfully.

At block 322, processor 200 generates a request to digital wallet 104 for digital wallet 104 to provide a response to the request. The request comprises the command issued by the user, as well as any related attributes of the command, such as one or more types of cryptocurrency. For example, the request may comprise the command “how much” and attributes Bitcoin and Ether. Since digital wallet 104 may be maintained by a distributed ledger network, such as distributed cryptocurrency exchange network 106 or by a different distributed network (not shown), processor 200 generally generates the request in accordance with a distributed ledger transaction request to perform whatever command the user intended. Alternatively, the request may be formatted in accordance with a “blockchain explorer” service, such as Etherscan, Polygonscan, BscScan, etc. In yet another embodiment, the request is formatted in accordance with a protocol of node provider 112.

In any case, at block 324, processor 200 sends the request to one of the aforementioned entities via network interface 204 and wide-area network 110.

At block 326, processor 200 receives a response to the request via network interface 204. For example, a total balance of the user's digital wallet, a value or amount of one or more particular cryptocurrencies owned by the user, etc. may be received from node provider 112, distributed cryptocurrency exchange network 106 or a blockchain explorer server.

At block 328, processor 200 generates a user response comprising at least a portion of the response received by processor 200 at block 326. Processor 200 than sends the user response to user device 102 via network interface 204 and wide-area network 110. The user response is formatted into instructions for user device 102 to present the user response audibly and/or tactilely to the user.

At block 330, user device 102 receives the user response and converts it into a non-visual response, such as a simulated human voice, that indicates the user's total digital wallet balance, a value or amount of each cryptocurrency contained in the digital wallet, etc.

At block 332, the user may select a different distributed ledger-based application or service, such as a cryptocurrency pricing service that provides real-time pricing information for one or more cryptocurrencies. Such pricing information may be provided by, for example, distributed cryptocurrency exchange network 106, or a webserver that utilizes distributed Oracle network 118. The user may select a cryptocurrency pricing service explicitly, for example, by saying “select cryptocurrency pricing” or a cryptocurrency pricing service may be accessed simply by issuing a verbal command, such as “what is the current price of Bitcoin and Ether?”.

At block 334, a command to obtain real-time pricing information for one or more cryptocurrencies is received by user device 102 and provided to accessibility webserver 122, as explained previously. In one embodiment, user device 102 generates a non-visual confirmation of the user's command, such as a simulated human voice that repeats the user's command. The confirmation may additionally request that the user approve the confirmation by speaking into user device 102, either approving or disapproving the confirmation.

At block 336, processor 200 of accessibility webserver 122 receives the command and processes it by generating a transcript, as explained above, and then applying an algorithm to the transcript in order to determine a particular command issued by the user, in this case, a command to obtain real-time pricing of one or more cryptocurrencies. The algorithm may also determine one or more attributes of the command, such as one or more types of cryptocurrency. In some embodiments, processor 200 compares the transcript to commands and associated information stored in memory 202 in order to ascertain the command issued by the user and any associated information therewith. In one embodiment, the algorithm used to interpret the transcript is tailored towards commands likely used by a distributed ledger-based cryptocurrency pricing application or service. In this example, the algorithm may be trained to identify words such as “check”, “price”, and various cryptocurrencies that could be the subject of a price inquiry, such as “Bitcoin”, “Ether”, “DAO”, “Ripple”, etc. In one embodiment, processor 200 additionally generates a confirmation and sends the confirmation to user device 102 via network interface 204 and wide-area network 110. The confirmation instructs user device 102 to provide an audible and/or tactile notification to the user that the user's command has been received and/or processed successfully.

At block 338, processor 200 generates a request to a distributed ledger-based application or service that provides real-time cryptocurrency pricing information. The request may be formatted in accordance with a particular application or service, such as a distributed ledger-based transaction proposal in an embodiment where the request is sent directly to a distributed ledger-based network that supports such real-time cryptocurrency pricing information, such as distributed exchange cryptocurrency exchange network 106. In another embodiment, the request is formatted in accordance with a protocol used by node provider 112. Processor 200 sends the request to a distributed ledger-based network or to node provider 112 via network interface 204 and wide-area network 110.

At block 340, a response is received from the real-time cryptocurrency pricing service or application via wide-network 110 and network interface 204, in some cases via node provider 112. The response is then typically reformatted into a user response message that instructs user device 102 to verbally notify the user of the cryptocurrency pricing, and the user response message is sent by processor 202 to user device 102 via network interface 204.

At block 342, the user response is converted by user device 102 into a non-visual response, such as a simulated human voice that announces the current price of one or more of the cryptocurrencies identified by the user in the user's earlier command.

At block 344, in yet another distributed ledger-based application or service, such as a cryptocurrency exchange service supported by distributed cryptocurrency exchange network 106. In this example, the user may wish to exchange one cryptocurrency owned by the user for a different cryptocurrency. The user may issue a verbal command, selecting a distributed ledger-based cryptocurrency exchange service or may simply issue a verbal command to exchange an amount of one cryptocurrency held by the user in digital wallet 104 for another cryptocurrency.

In any case, at block 346, user device 102 receives the selection or command and sends it to accessibility webserver 122, as explained previously. In one embodiment, user device 102 presents an audible and/or tactile confirmation to the user that the user's selection or command was received and/or sent to accessibility webserver 122 successfully.

At block 348, processor 200 of accessibility webserver 122 receives the selection or command and again processes it by generating a transcript and applying an algorithm to the transcript to determine which command was spoken by the user and any other information associated with the command. In this example, processor 200 determines that the user requested a cryptocurrency exchange of $100 worth of cryptocurrency A for cryptocurrency B, for example. In one embodiment, the algorithm used to interpret the transcript is tailored towards commands likely used by a distributed ledger-based cryptocurrency exchange application or service. In this example, the algorithm may be trained to identify words such as “exchange”. “swap”, and various cryptocurrencies that could be the subject of an exchange, such as “Bitcoin”, “Ether”, “DAO”, “Ripple”, etc. In one embodiment, processor 200 additionally generates a confirmation and sends the confirmation to user device 102 via network interface 204 and wide-area network 110. The confirmation instructs user device 102 to provide an audible and/or tactile notification to the user that the user's command has been received and/or processed successfully.

At block 350, processor 200 generates a request to distributed cryptocurrency exchange network 106, or node provider 112, to exchange an amount of cryptocurrency A for cryptocurrency B. Processor 200 may generate the request in accordance with a distributed ledger transaction proposal. Alternatively, the request may be formatted in accordance with a protocol used by node provider 112. The request comprises information needed to exchange the recited cryptocurrencies, in one embodiment, in a format that allows the transaction request to be validated by each computing node 108 of distributed cryptocurrency exchange network 106.

At block 352, processor 200 sends the request to distributed cryptocurrency exchange network 106 or node provider 112 via network interface 204 and wide-area network 110.

At block 354, processor 200 receives a response to the request via network interface 204, indicating whether or not the exchange occurred and, in some embodiments, providing a value or an amount of cryptocurrencies in digital wallet 104 after the exchange. The response may additionally comprise an identification of a new block created by distributed cryptocurrency exchange network 106 as a result of validating the exchange.

At block 356, processor 200 generates a user response message, the user response message comprising at least a portion of the response received by processor 200 at block 326. Processor 200 than sends the user response message to user device 102 via network interface 204 and wide-area network 110. The user response is formatted into instructions for user device 102 to present the user response audibly and/or tactilely to the user.

At block 358, user device 102 receives the notification and converts it into a non-visual response, such as a simulated human voice that announces that the exchange was successful, and in some embodiments, a current value or an amount of cryptocurrencies in digital wallet 104 after the exchange and an identification of the newly-created block on the blockchain produced by distributed cryptocurrency exchange network 106.

At block 360, the user may select a yet another distributed ledger-based application or service, such as participation in a DAO. The user may be a member of a DAO and have a right to vote on new proposals from other members concerning the DAO, as well as to submit new proposals to the other members. The user may select a DAO application or service from the dashboard by, saying, for example, “select DAO” or by issuing a direct verbal command, such as “Generate new proposal”.

At block 362, in one embodiment, after the user has verbally requested to participate in the DAO, user device 102 may send the user's selection to accessibility webserver 102.

At block 364, either in response to receiving the user's request to participate in the DAO, or in response to sending the request to accessibility webserver 122, user device 102 may generate a non-visual notification to the user, such as a chime, short audio clip, tactile alert, etc., indicating that device 102 has successfully received the user's request. In another embodiment, the non-visual notification is provided by user device 102 only after user device 102 sends the user's request to accessibility webserver 122 and then receives an acknowledgment from accessibility webserver 122 that the user's request was received successfully.

At block 366, processor 200 of accessibility webserver 122 receives the user's request from user device 102 and, in response, may provide a listing of available commands for use with the DAO application or service, stored in memory 202 in association with the DAO service. The listing is sent to user device 102 by processor 200 via network interface 104 and wide-area network 100.

At block 368, the listing of available commands is received by user device 102, and user device 102 converts the listing to one or more non-visual notifications to the user, indicating the commands available to the user while using the DAO application or service.

At block 370, the user may issue a verbal command such as “Generate new proposal”. This command is received by user device 102 and provided to accessibility webserver 122. In one embodiment, user device 102 presents an audible and/or tactile confirmation to the user that the user's command was received and/or sent to accessibility webserver 122 successfully.

At block 372, processor 200 of accessibility webserver 122 receives the command from user device 102 via wide-area network 110 and network interface 204. In response, processor 200 processes the command by generating a transcript, as explained above, and then applying an algorithm to the transcript in order to determine a particular command issued by the user, in this case, a command to create a new DAO proposal. In one embodiment, the algorithm used to interpret the transcript is tailored towards commands likely used by a distributed ledger-based DAO application or service. In this example, the algorithm may be trained to identify words such as “New Proposal”, “approve”, and “disapprove”. In one embodiment, processor 200 additionally generates a confirmation and sends the confirmation to user device 102 via network interface 204 and wide-area network 110. The confirmation instructs user device 102 to provide an audible and/or tactile confirmation to the user that the user's command has been received and/or processed successfully.

At block 374, processor 200 generates a request in response to the command, such as request for the user to provide a reference designation to the user's new proposal, such as a title of the new proposal. The request is sent by processor 200 to user device 102 via network interface 204 and wide-area network 110.

At block 376, the request is received by user device 102 and provided non-visually to the user.

At block 378, the user may verbally provide a reference designator to the user's new proposal, such as “Proposal 123”. User device 102 receives the verbal reference designator and provides it to accessibility webserver 122. User device 102 may also generate a non-visual confirmation that the reference designator was received successfully, and provide it to the user audibly and/or tactilely.

At block 380, processor 200 of accessibility webserver 122 receives the reference designator and, in response, may generate a confirmation of receipt of the reference designator and provide it to the user via device 102. User device receives the confirmation and provides the confirmation to the user audibly and/or tactilely.

At block 382, processor 200 generates a request for the user to provide the new proposal. The request is sent by processor 200 via network interface 204 and wide-area network 100 to user device 102.

At block 384, user device 102 receives the request from accessibility webserver 122 and converts it into a non-visual request, such as a simulated human voice asking the user to provide the user's new proposal.

At block 386, the user may verbally provide the user's new proposal to user device 102, where it is received and provided to accessibility webserver 122. User device 102 may also generate a non-visual confirmation that the new proposal was received successfully, and provide it to the user.

At block 388, processor 200 of accessibility webserver 122 receives the new proposal and processes it by converting it into a transcript, as previously explained herein. In one embodiment, processor 200 additionally generates a confirmation and sends the confirmation to user device 102 via network interface 204 and wide-area network HO, The confirmation instructs user device 102 to provide an audible and/or tactile notification to the user that the user's new proposal has been received and/or processed successfully.

At block 390, processor 200 generates a new DAO proposal based on the user-provided reference designator and the new proposal. The new DAO proposal may be generated in accordance with a distributed ledger-based protocol used by distributed DAO network 114 to receive and process newly transaction proposals, such as the new DAO proposal from accessibility webserver 122. Alternatively, the new DAO proposal may be formatted in accordance with a protocol used by node provider 112. Each computing node 116 in distributed DAO network 114 typically executes a smart contract that manages new DAO proposals, where new DAO proposals are validated by each computing node 116 using distributed ledger-based validation techniques well known in the art, such as Proof of Work, Proof of Stake, etc. Distributed DAO network 114 sends the new DAO proposal to other members of the DAO after validation. Other members of the DAO receive the new DAO proposal from distributed DAC) network 114 and cast votes to either approve or disapprove the new DAO proposal. Each member sends their vote to distributed DAO network 114 where the votes are validated, tallied and a result determined by the smart contract. After the result is determined, the smart contract may provide the result for validation by computing nodes 116 and, if validated, published on a DAO blockchain ledger produced by distributed DAO network 114. After publication on the DAO blockchain, distributed DAO network 114 may notify accessibility webserver 122 and/or node provider 112 of the result or, in another embodiment, accessibility webserver 122 may periodically check the DAO blockchain to see if the user's proposal, identified by the reference designator, or by some other designator, has been approved or disapproved by the other DAC) members.

At block 392, processor 200 of accessibility webserver 122 receives the result of the new DAO proposal via network interface 204 and wide-area network 110, either directly from distributed DAO network 114 or from node provider 112.

At block 394, processor 200 generates and sends a user response message to user device 102 with an indication of the result of the new DAO proposal. The user response message may include an indication that the result was published onto the DAO blockchain ledger and, in some embodiments, an identification a new block created by distributed DAO network 114 as a result of validating the approval or disapproval.

At block 396, user device 102 receives the user response message from accessibility webserver 122 and converts it into a non-visual notification of the result of the user's new DAO proposal, such as a simulated human voice that announces whether or not the user's new DAC) proposal was approved by the other members of the DAO and, in some embodiments, that the result was published on the DAO blockchain ledger and an identification of a newly-created block by distributed DAO network 114.

At block 398, the user may select a yet another distributed ledger-based application or service, such as an information retrieval application or service. One example of such a distributed ledger-based information retrieval application or service is the Truflation distributed economic and financial information service at www.Truflation.com. The Truflation service utilizes distributed Oracle network 118, which comprises a plurality of computing nodes 120 that each independently validates real-world information, such as financial and economic statistics, from a variety of sources. Once a particular statistic has been validated by the computing nodes 120, distributed Oracle network 118 may update a distributed Oracle blockchain ledger, memorializing one or more validated statistics for use by informational applications and services such the Truflation service. The user may select the Truflation service by saying, for example, “select Initiation”.

At block 400, in one embodiment, after the user has verbally requested to access the Truflation service, user device 102 may send the user's selection to accessibility webserver 102.

At block 402, either in response to receiving the user's request to use the Truflation service, or in response to sending the request to accessibility webserver 122, user device 102 may generate a non-visual confirmation to the user, such as a chime, short audio clip, tactile alert, etc., indicating that device 102 has successfully received the user's request. In another embodiment, the non-visual notification is provided by user device 102 only after user device 102 sends the user's request to accessibility webserver 122 and then receives an acknowledgment from accessibility webserver 122 that the user's request was received by accessibility webserver 122 successfully.

At block 404, processor 200 of accessibility webserver 122 receives the user's request from user device 102 and, in response, may provide a listing of available commands for use with the Initiation service, stored by memory 202 in association with the Truflation service. Examples of commands comprise “check United States inflation for current year”, “check current 10-year bond rate”, or, more generally, “tell Truflation what information you would like to receive. For example, you may ask about a particular inflation rate for any country, time period, and/or commodity category type”. The listing is sent to user device 102 by processor 200 via network interface 104 and wide-area network 110.

At block 406, the listing of available commands is received by user device 102, and user device 102 converts the listing to one or more non-visual notifications to the user, indicating the commands available to the user while using the Truflation service.

At block 408, the user may issue a verbal command such as “Check the inflation rate in 2022 for food in the US”. This command is received by user device 102 and provided to accessibility, webserver 122. User device 102 may also generate a non-visual confirmation that the command was received successfully, and provide it to the user.

At block 410, processor 200 of accessibility webserver 122 receives the command from user device 102 via wide-area network 110 and network interface 204. In response, processor 200 processes the command by generating a transcript, as explained above, and then applying an algorithm to the transcript in order to determine a particular command issued by the user, in this case, a command to check the inflation rate in 2022 for food in the United States. In one embodiment, the algorithm used to interpret the transcript is tailored towards commands likely used by the particular distributed ledger-based service or application. For example, in the Truflation example, the algorithm may be trained to identify words likely to appear with such a service, such as “check”, “inflation”, various jurisdictions such as cities, states or countries, category type such as “food”, “gas”, “healthcare”, etc.

At block 412, in one embodiment, processor 200 of accessibility webserver 122 receives the command from user device 102 and, in response, may generate a non-visual confirmation of receipt of the command and provide it to the user via device 102.

At block 414, processor 200 generates a request, based on the results of processing the command received from user device 102, in accordance with either a protocol used by a Truflation webserver (not shown) or a protocol used by node provider 112, and sends the request either to the Truflation webserver or to node provider 112, via network interface 204 and wide-area network 110.

At block 416, the request is received by the Truflation webserver and processed. The requested information is retrieved by the Truflation webserver from distributed Oracle network 118. In this example, distributed. Oracle network 118 may provide the inflation rate in 2022 for food in the US based on a latest block of the blockchain ledger produced by distributed Oracle network 118. The inflation rate may then be provided to the Truflation webserver, to node provider 112 or directly to accessibility webserver 122.

At block 418, processor 200 of accessibility webserver 122 receives the result of the request, i.e., the inflation rate for food in the United States in 2022, via network interface 204 and wide-area network 110, either directly from the Truflation webserver, from node provider 112 or directly from distributed Oracle network 118.

At block 420, processor 200 generates and sends a user response message to user device 102 with an indication of the result of the user's request, i.e., the inflation rate for food in the United States in 2022. The user response message may include an indication that the result was obtained from the distributed Oracle network 118 blockchain ledger and an identification of one or more blocks on a blockchain created by distributed Oracle network 118 that contains the requested statistic(s).

At block 422, user device 102 receives the user response message from accessibility webserver 122 and converts it into a non-visual notification, such as a simulated human voice that announces the current inflation rate for food in the United States in 2022 and, in some embodiments, that the result was obtained from the distributed Oracle network 118 blockchain ledger, and an identification of the one or more blocks on the blockchain created by distributed Oracle network 118 that contains the requested statistic(s).

In the description above, certain aspects and embodiments of the invention may be applied independently and some of them may be applied in combination as would be apparent to those of skill in the art. For the purposes of explanation, specific details are set forth in order to provide a thorough understanding of embodiments of the invention.

The above description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the embodiments as set forth in the appended claims.

Although specific details are given to provide a thorough understanding of at least one embodiment, it will be understood by one of ordinary skill in the art that some of the embodiments may be practiced without disclosure of these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a method, a process or an algorithm performed by a processor, which may be depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. The terms “computer-readable medium”, “memory”, “storage medium”, and “memory” includes, but is not limited to, portable or non-portable electronic memories, optical storage devices, and various other mediums capable of storing, containing, or carrying instruction(s) and/or data. These terms each may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, RAM, ROM, flash memory, solid state disk drives (SSD), etc. A computer-readable medium or the like may have stored thereon code and/or processor-executable instructions that may represent a method, algorithm, procedure, function, subprogram, program, routine, subroutine, or any combination of instructions, data structures, or program statements.

Furthermore, embodiments may be implemented by hardware, software, firmware, middleware, microcode, hardware description languages, or any combination thereof. When implemented in software, firmware, middleware or microcode, the program code, i.e., “processor-executable code”, or code symbols to perform the necessary tasks (e.g., a computer-program product) may be stored in a computer-readable or machine-readable medium. A processor(s) may perform the necessary tasks.

We claim:

1. An accessibility webserver for providing distributed ledger-based applications or services to visually-impaired users, comprising:
a memory for storing processor-executable instructions;
a network interface; and
a processor, coupled to the memory and the network interface, for executing the processor-executable instructions that causes the accessibility webserver to:
provide, by the processor via the network interface, a listing of commands available for use with a distributed ledger-based application or service to a user device over a wide-area network, the listing of commands formatted for the user device to audibly provide the listing of commands to a user of the user device;
receive, by the processor via the network interface, a command for the distributed ledger-based application or service to perform an action, the command provided audibly by the user to the user device;
determine, by the processor, a first action to be performed by the distributed ledger-based application or service based on the received command;
generate, by the processor, a formatted command comprising the first action, the formatted command formatted for processing by the distributed ledger-based application or service;
send, by the processor via the network interface, the formatted command for receipt by the distributed ledger-based application or service;
receive, by the processor via the network interface, a response from the distributed ledger-based application or service, the response comprising validated information by a plurality of computing nodes of the distributed ledger-based application or service; and
provide, by the processor via the network interface, a user response to the user device based on the response, the user response configured for the user device to provide an audible response to the user.

2. The accessibility webserver of claim 1, wherein the processor-executable instructions comprise further instructions that causes the accessibility webserver to:
provide, by the processor via the network interface, a confirmation to the user device, confirming that the accessibility webserver received the command, the confirmation formatted for the user device to audibly provide the confirmation to the user.

3. The accessibility webserver of claim 1, wherein the processor-executable instructions for determining a first action to be performed by the distributed ledger-based application or service comprises instructions that causes the accessibility webserver to:
convert, by the processor, the command into a transcript; and
apply, by the processor, an algorithm to the transcript for determining a first command, from a plurality of predetermined commands stored in the memory, desired by the user;
wherein the formatted command comprises the first command, formatted into a distributed ledger-based validation proposal.

4. The accessibility webserver of claim 3, wherein the processor further applies the algorithm to the transcript to further determine a first cryptocurrency from a plurality of cryptocurrency descriptors stored in the memory;
wherein the formatted command additionally comprises a descriptor of the first cryptocurrency.

5. The accessibility webserver of claim 4, wherein the distributed ledger-based application or service comprises a digital wallet, the first action comprises retrieving a balance of a particular cryptocurrency in the digital wallet, the response comprises the balance of the particular cryptocurrency in the digital wallet, and the audible response comprises a simulated human voice announcing the balance of the particular cryptocurrency in the digital wallet.

6. The accessibility webserver of claim 4, wherein the distributed ledger-based application or service comprises a cryptocurrency exchange service and the processor-executable instructions comprise further instructions for causing the accessibility web server to:
apply, by the processor, the algorithm to the transcript to further determine a second cryptocurrency from the plurality of cryptocurrency descriptors stored in the memory;
apply, by the processor, the algorithm to the transcript to further determine an amount of the first cryptocurrency specified by the user in the command; and
determine, by the processor, an amount of a first cryptocurrency associated with the first cryptocurrency descriptor to exchange based on the comparison of the transcript to the plurality of cryptocurrency amounts stored in the memory;
wherein the first action comprises exchanging the amount of the first cryptocurrency for the second cryptocurrency, the response comprises a confirmation that the exchange has occurred from the cryptocurrency exchange service, and the audible response comprises a simulated human voice announcing that the exchange has occurred.

7. The accessibility webserver of claim 1, wherein the audible response additionally identifies a blockchain network where the result was validated.

8. The accessibility webserver of claim 4, wherein the distributed ledger-based application or service comprises a distributed autonomous organization (DAO) application, the first action comprises submitting a new DAO proposal to a distributed DAO network for acceptance by members of a DAO, the response comprises an indication from the distributed DAO network that the new DAO proposal was approved, and the audible response comprises a simulated human voice announcing that the DAO proposal was approved.

9. The accessibility webserver of claim 8, wherein the audible response further comprises an identity of a blockchain network where the new DAO proposal was validated.

10. The accessibility webserver of claim 4, wherein the distributed ledger-based application or service comprises distributed ledger-based inflation reporting service, the first action comprises checking an inflation statistic, the response comprises a value of the inflation statistic, the inflation statistic validated by a distributed Oracle network, and the audible response comprises a simulated human voice announcing the value of the inflation statistic.

11. The accessibility webserver of claim 10, wherein the audible response further comprises an identity of the distributed Oracle network where the inflation statistic was validated.

12. A method, performed by an accessibility webserver for providing distributed ledger-based applications or services to visually-impaired users, comprising:
providing a listing of commands available for use with a distributed ledger-based application or service to a user device over a wide-area network, the listing of commands formatted for the user device to audibly provide the listing of commands to a user of the user device;
receiving a command for the distributed ledger-based application or service to perform an action, the command provided audibly by the user to the user device;
determining a first action to be performed by the distributed ledger-based application or service based on the received command;
generating a formatted command comprising the first action, the formatted command formatted for processing by the distributed ledger-based application or service;
sending the formatted command for receipt by the distributed ledger-based application or service;
receiving a response from the distributed ledger-based application or service, the response comprising validated information by a plurality of computing nodes of the distributed ledger-based application or service; and
providing a user response to the user device based on the response, the user response configured for the user device to provide an audible response to the user.

13. The method of claim 12, further comprising:
providing a confirmation to the user device, confirming that the accessibility webserver received the command, the confirmation formatted for the user device to audibly provide the confirmation to the user.

14. The method of claim 12, wherein determining a first action to be performed by the distributed ledger-based application or service comprises:
converting the command into a transcript; and
applying an algorithm to the transcript for determining a first command, from a plurality of predetermined commands stored in the memory, desired by the user;
wherein the formatted command comprises the first command, formatted into a distributed ledger-based validation proposal.

15. The method of claim 14, further comprising:
applying the algorithm to the transcript to further determine a first cryptocurrency from a plurality of cryptocurrency descriptors;
wherein the formatted command additionally comprises a descriptor of the first cryptocurrency.

16. The method of claim 15, wherein the distributed ledger-based application or service comprises a digital wallet, the first action comprises retrieving a balance of a particular cryptocurrency in the digital wallet, the response comprises the balance of the particular cryptocurrency in the digital wallet, and the audible response comprises a simulated human voice announcing the balance of the particular cryptocurrency in the digital wallet.

17. The method of claim 15, wherein the distributed ledger-based application or service comprises a cryptocurrency exchange service and the method further comprises:
applying the algorithm to the transcript to further determine a second cryptocurrency from the plurality of cryptocurrency descriptors;
applying the algorithm to the transcript to further determine an amount of the first cryptocurrency specified by the user in the command; and
determining an amount of a first cryptocurrency associated with the first cryptocurrency descriptor to exchange based on the comparison of the transcript to the plurality of cryptocurrency amounts stored in the memory;
wherein the first action comprises exchanging the amount of the first cryptocurrency for the second cryptocurrency, the response comprises a confirmation that the exchange has occurred from the cryptocurrency exchange service, and the audible response comprises a simulated human voice announcing that the exchange has occurred.

18. The method of claim 12, wherein the audible response additionally identifies a blockchain network where the result was validated.

19. The method of claim 15, wherein the distributed ledger-based application or service comprises a distributed autonomous organization (DAO) application, the first action comprises submitting a new DAO proposal to a distributed DAO network for acceptance by members of a DAO, the response comprises an indication from the distributed DAO network that the new DAO proposal was approved, and the audible response comprises a simulated human voice announcing that the DAO proposal was approved.

20. The method of claim 19, wherein the audible response further comprises an identity of a blockchain network where the new DAO proposal was validated.

21. The method of claim 15, wherein the distributed ledger-based application or service comprises distributed ledger-based inflation reporting service, the first action comprises checking an inflation statistic, the response comprises a value of the inflation statistic, the inflation statistic validated by a distributed Oracle network, and the audible response comprises a simulated human voice announcing the value of the inflation statistic.

22. The method of claim 21, wherein the audible response further comprises an identity of the distributed Oracle network where the inflation statistic was validated.
